(19) United States
(12) Patent Application Publication
(10) Pub. No.: US 2021/0374325 A1
(43) Pub. Date: Dec. 2, 2021

(54) System and method for providing a spreadsheet with cells having both text and evaluable subcells

(71) Applicant: Steven Schweizer, Urbandale, IA (US)

(72) Inventor: Steven Schweizer, Urbandale, IA (US)

(21) Appl. No.: 16/883,649

(22) Filed: May 26, 2020

(51) Int. Cl. G06F 40/111; G06F 40/18

(52) U.S. Cl. CPC G06F 40/111; G06F 40/18

(57) ABSTRACT

The present disclosure is directed to using subcells to display both text and mathematically evaluable information within a cell of a spreadsheet. An algorithm can be applied to user-specified cell data to determine if the data are mathematically evaluable or not. If the user-specified cell data are not mathematically evaluable, such as the case when the data are text characters, the data are displayed within the cell as input. If the user-specified cell data are mathematically evaluable, such as the case when the data are a mathematical expression, the data can be evaluated and the resulting solution displayed within the cell. The cell can be used as a portion of a mathematical expression associated with a different cell, wherein the text data may be ignored and the solution to the mathematical expression used to solve the mathematical expression associated with the different cell.

### TECHNICAL FIELD

The following disclosure relates generally to spreadsheets and, more particularly, to inputting text and mathematical operands into a cell of a spreadsheet.

### BACKGROUND

Spreadsheets are well known in the art and useful for a variety of tasks, including creating and manipulating arrays of cells containing numbers and mathematical expressions. One drawback associated with spreadsheets is the difficulty in creating, manipulating, and positioning user-specified text. Another drawback associated with prior art spreadsheets is the difficulty in manipulating numbers and mathematical expressions inside spreadsheet cells that also contain text.

Another drawback associated with prior art spreadsheets is their rigidity and overabundance of unused cells. These unused cells require excess computing resources, such as memory and processor time. It would therefore be desirable to provide a system for providing a spreadsheet that minimized the number of unused cells.

Word processing systems also allow the insertion of fields within paragraphs of text and insertion of tables with an array of cells into documents. One drawback associated with prior art word processing systems is that they do not allow these inserted fields and tables to be mathematically evaluated from other fields and tables in the document and do not allow these inserted fields and cells to be mathematically evaluable or evaluated in the same manner that such fields and cells are evaluable within dedicated spreadsheets systems. It would therefore be desirable to provide a system for providing a spreadsheet having both text and evaluable subcells.

### SUMMARY OF THE DISCLOSED SUBJECT MATTER

Systems and methods of the present disclosure are directed to incorporating text and mathematical operands into cells of a spreadsheet within a document. The technology can differentiate between text and operands within a spreadsheet cell and incorporate an operand within the cell into mathematical expressions that may be displayed in other cells of the spreadsheet. By allowing text that is not mathematically evaluable and mathematically evaluable operands to be input into the same spreadsheet cell, users are no longer limited to evaluable-only cells and nonevaluable-only cells. In an illustrative implementation, a user can input a number and a text string into the same cell and then perform mathematical operations on the number within the cell.

At least one aspect of the present disclosure is directed to a method of inputting mathematical operands into a cell containing text. In some implementations, the mathematical operand is a number, while in other implementations the operand is the result of another mathematical operation, such as the sum of values contained within another row, column, cell, or subcell of the spreadsheet. In a case where the operand is a sum of values contained within another row the text displayed within the cell may remain static, while the operand displayed within the cell changes as the operands within other cells in the spreadsheet change.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

For a better understanding of the aforementioned embodiments of the invention as well as additional embodiments thereof, reference should be made to the Description of Embodiments below, in conjunction with the following drawings in which like reference numerals refer to corresponding parts throughout the figures.

FIG. 1 illustrates a component diagram of components included in a typical implementation of the system in the context of a typical operating environment;

FIG. 2 illustrates a screen display of a rendered document of the prior art having a table of rows and columns containing evaluable cells.

FIG. 3 illustrates a screen display of a rendered document of the prior art having a table of rows and columns containing empty and merged evaluable cells in accordance with some embodiments.

FIG. 4 illustrates pseudocode detailing software architecture capable of producing a spreadsheet having a table of rows and columns of contiguous and noncontiguous evaluable cells in accordance with some embodiments.

FIG. 5 illustrates pseudocode detailing cell storage software architecture in accordance with some embodiments.

FIG. 6 illustrates pseudocode detailing cell evaluation, formatting, and cell content display software architecture in accordance with some embodiments.

FIG. 7 illustrates a screen display of a rendered document having a table of rows and columns of contiguous and noncontiguous evaluable cells in accordance with some embodiments.

FIG. 8 illustrates a screen display of a rendered document having a table of rows and columns of contiguous and noncontiguous evaluable cells, wherein the column headings have shifted to reflect the location of the cursor in accordance with some embodiments.

FIG. 9 illustrates a screen display of a rendered document having a table of rows and columns of contiguous evaluable cells, and an evaluable cell comprising a nonevaluable textual input and an evaluable subcell input in accordance with some embodiments.

FIG. 10 illustrates the document of FIG. 9 as printed in accordance with some embodiments.

FIG. 11 illustrates a screen display of a rendered document of the prior art having multiple printed pages of a table, wherein all rows comprise all columns and wherein all columns comprise all rows.

FIG. 12 illustrates a screen display of a rendered document having a table of rows and columns, wherein not all rows comprise all columns and wherein not all columns comprise all rows in accordance with some embodiments.

### DESCRIPTION OF EMBODIMENTS

In general, techniques of this disclosure may enable a user to customize a spreadsheet, a word processing document, a table, and a spreadsheet within a word processing document. More specifically, these techniques allow a user to incorporate text and mathematical operands into cells of a table, whether that table is within a spreadsheet or a word processing document. This technology is capable of differentiating between text and operands within a spreadsheet cell and allowing operands within the cell to be incorporated into mathematical, string, or textual expressions that may be displayed in other cells of the spreadsheet. These techniques free the user from having to choose between nonevaluable-only cells, such as prior art cells containing text, and evaluable-only cells, such as prior art cells containing numbers or formulae. The techniques of this disclosure allow a user to input a number and a text string into the same spreadsheet cell and then perform mathematical operations on the number within the cell.

Just as the text a user enters into a spreadsheet cell of the present disclosure may be various types of text known in the art, the mathematical operand the user enters into that same cell may be a number or the result of another mathematical operation, such as the sum of values contained within another row or column of the spreadsheet. Even if those sum as values of other cells in the spreadsheet change, the text in the cell remains unaffected and does not affect the changing calculation of the sum.

### Exemplary Devices

Reference will now be made in detail to embodiments, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first image could be termed a second image, and, similarly, a second image could be termed a first image, without departing from the scope of the present invention. The first image and the second image are both images, but they are not the same image.

The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as application and other smart phone functions. Exemplary embodiments of portable multifunction devices include, without limitation, the iPhone®, and iPad® devices from Apple Inc. of Cupertino, Calif. Other portable electronic devices, such as laptops or tablet computers with touch-sensitive surfaces (e.g., touch screen displays and/or touch pads) may also be used. It should also be understood that, in some embodiments, the device is not a portable communications device, but is a desktop computer with a touch-sensitive surface (e.g., a touch screen display and/or a touch pad).

In the discussion that follows, an electronic device that includes a display and a touch-sensitive surface is described. It should be understood, however, that the electronic device may include one or more other physical user-interface devices, such as a physical keyboard, stylus, a mouse and/or a joystick.

The device typically supports a variety of applications, such as one or more of the following: a telephone application, an e-mail application, an instant messaging application, a photo management application, a digital camera application, a digital video camera application, a web browsing application, a digital music player application, and/or a digital video player application.

In the following description, certain well-known components, such as hard drives, processors, operating systems, power supplies, routers, identity management systems, workflow orchestrators, process schedulers, virtual machines, middleware, enterprise databases, and so on, are not necessarily explicitly called out in the figures. It should be noted that those skilled in the art with the teachings of the present disclosure before them will understand which components to implement and how to implement them to address the needs of a given implementation.

As used herein, software functionality includes any function, capability, or feature, e.g., stored or arranged data, that is provided via computer code, e.g., software. Software functionality may, in general, be accessible via use of a user interface (UI), and accompanying user interface controls and features such as those known in the art.

In exemplary embodiments, a UI control may include any displayed element or component of a UI display screen, that is adapted to allow a user to provide input, view data, and/or otherwise interact with a UI. Additional examples of UI controls include buttons, drop down menus, menu items, tap-and-hold functionality, etc. Similarly, a UI control signal includes any signal provided as input for software, where the input affects a UI display screen and/or accompanying software application associated with the software.

A UI display screen includes any software-generated depiction presented on a display. Examples of depictions include windows, dialog boxes, displayed tables, and any other graphical UI features, such as UI controls, presented to a user via software, such as a browser. As used herein, a UI display screen contained within a single border is called a view or window. Views or windows may include sections, such as sub-views or sub-windows, dialog boxes, graphs, tables, etc. In certain embodiments, a UI display screen may refer to all application windows presently displayed on a display. As used herein, the terms UI display screen and screen may be employed interchangeably.

Attention is now directed toward embodiments of the system and method for inputting text and mathematical operands into a cell of a spreadsheet.

Word processing systems handle word processing functions well and spreadsheets handle spreadsheet functions well. While word processing systems often have some spreadsheet functionality, that functionality is typically limited. Similarly, while spreadsheet systems often have some word processing functionality, this functionality is also limited. It would be desirable for a user to combine the benefits of a spreadsheet processing system and a word processing system in a manner that allowed the user to place nonevaluable text within an evaluable cell of a spreadsheet and then place an evaluable subcell within that same cell, all while retaining addressability of the cell and the subcell by other tables, cells, and subcells. The embodiments described below address this problem by providing a spreadsheet system and method that allows the insertion, in a document, of evaluable subcells within evaluable cells that may also contain nonevaluable text. Upon insertion, the subcells remain fully evaluable and evaluable by other tables, cells, and subcells within the document. These subcells may address, and are evaluable by, both contiguous and noncontiguous cells in a manner similar to how prior art cells are evaluable in prior art spreadsheets.

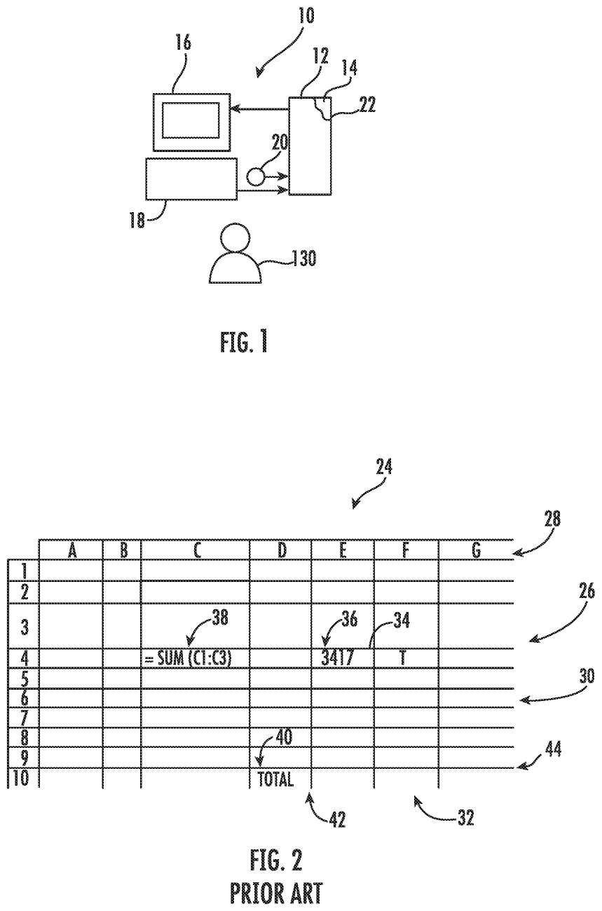

FIG. 1 illustrates a block diagram of an example computer-implemented method for employing an operating system (10) for a digital spreadsheet application for implementations described herein. Shown is a computer (12) having memory (14) containing computer-executed instructions for processing information and running applications. The computer (12) is preferably provided with a display (16) and input devices, such as a keyboard (18) and a mouse (20). The computer (12) may be a stationary or mobile device, such as those known in the art. In various implementations, the computer (12) runs a spreadsheet application (22).

FIG. 2 illustrates an digital spreadsheet application (24) of the prior art. As shown, the spreadsheet application (24) renders a matrix of cells in the form of a table (26) having headers (28), rows (30), and columns (32). As used herein, headers (28), rows (30), and columns (32) are used to designate items associated with one another in the application (24), in a manner such as that known in the art, regardless of whether the items are ever displayed contiguous with one another or not. For example, a row (30) may comprise a plurality of cells (34) even if those cells (34) are displayed in alignment with one another or not. Typically, as known in the art, the designation of headers (28), rows (30), and columns (32), allows the application (24) to simultaneously affect a group of cells (34) or fields designated as being in a particular header (28), row (30), or column (32). This also provides a basis for the application to address particular cells (34) by reference to the particular header (28), row (30), or column (32) designation associated with the cell (34).

As shown, the spreadsheet application (24) has nonevaluable headers (28) and rows (30) and columns (32) of cells (34) that are all adjacent to one another. As shown, the cells (34) may contain evaluable values (36) or evaluable formulae (38) or nonevaluable text (40). The headers (28) are not evaluable.

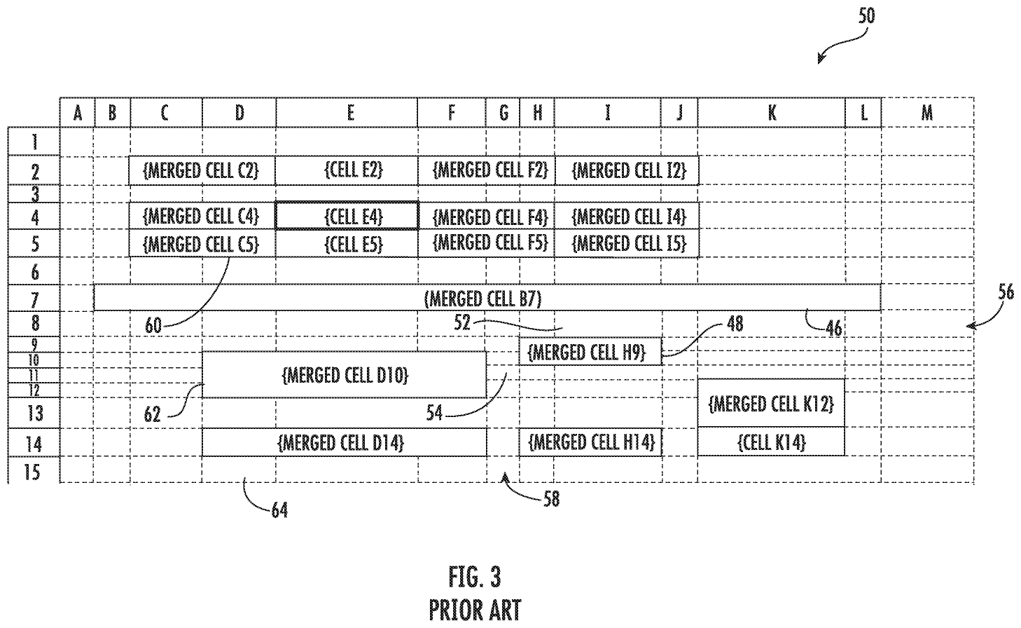

Each row (30) is adjacent to, and aligned with, all neighboring rows (30). Similarly, each column (32) is adjacent to, and aligned with, all neighboring columns (32). Due to this forced adjacency, all column borders (42) and row borders (44) must remain aligned throughout the table (26). As shown in Fig.3, there are multiple ways to give the impression of cells (46) and (48) in a prior art spreadsheet table (50) being noncontiguous. One way to accomplish this is to leave cells (52) and (54) empty between rows (56) and columns (58). The cells (46) and (48) actually remain contiguous with neighboring cells. It is just that the empty intervening cells (52) and (54) give the illusion the cells (46) and (48) being noncontiguous. While this arrangement gives the illusion of noncontiguous cells (46) and (48), the arrangement involves the use of unused cells (52) and (54), as well as extra unused rows (56) and columns (58).

A user of the prior art table (50) can also create different sized cells (60) and (62) within the same column (64) by merging cells together. As shown in FIG. 3, cell (60) is a merger of two columns (C and D) within row 5 of the table (50). Similarly, cell (62) is a merger of nine cells in three columns (D, E, and F) and three rows (10, 11, and 12). In this prior art example, cells D11, D12, E10, E11, E12, F10, F11, and F12 still exist, they are merely hidden. To accomplish the desired layout in FIG. 3, the user only wants 4 cells in any one row, and only 6 rows. Since prior art spreadsheets do not allow for this layout of cells without any intervening cells, the user must use 14 rows and 12 columns to accomplish this layout in this prior art spreadsheet table (50). The use of merged cells in the prior art make it more difficult to copy and paste formulae that use relative cell addresses in that when pasted in new cells the formulae using relative cell addresses often reference incorrect cells. This often requires the use of absolute cell references in these situations that must be manually corrected every time the formulae are copied or cut, and pasted into new cells. An additional problem with such prior art layouts is that if it is desired to change the width of a cell, the widening will shift other cells in that same row and other cells in the same column, making it difficult to maintain the desired formatting.

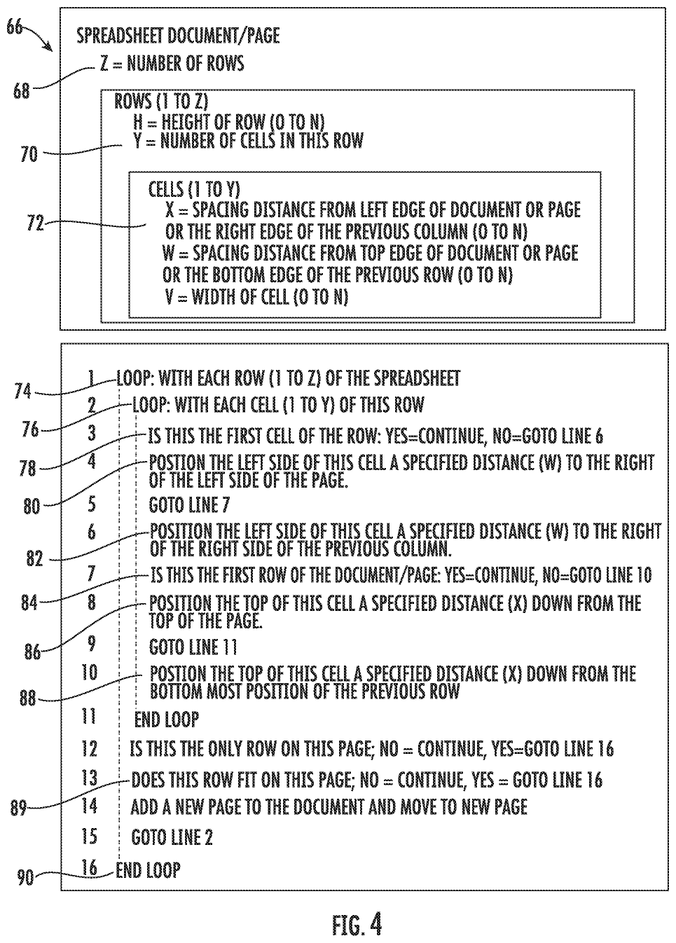

FIG. 4 shows pseudocode (66) explaining the coding architecture of the software of the system (10) to be used in association with base prior art spreadsheet code. According to some implementations the base prior art spreadsheet code configures table (26) in spreadsheet (22) to automatically render rows (30), columns (32), and cells (34) and, if desired, populate cells (34) associated with attributes (fields) with input data in a desired format. The base prior art spreadsheet code may be any such code known in the art. The pseudocode (66) of FIG. 4 describes one improvement system (10) adds to base prior art spreadsheet code which, in this embodiment, is the improvement of providing custom location and relocation of cells in a spreadsheet. As shown in FIG. 4, the pseudocode (66) shows the coding architecture begins (68) with a spreadsheet having “z” defined number of rows, and defines (70) “y” number of cells in each row 1-z. The system (10) allows the “y” number of cells to be independently defined for each row, independently of the number of cells in any other row or column.

For each cell 1-y, the architecture defines (72) a variable “x” representing the spacing of the cell from a top edge of the document or page, or from the bottom edge of the previous cell in the same row (in units 0 to “n”) and a variable “w” representing the spacing of the cell from the left edge of the document or page, or from the right edge of the previous cell in the same row (also in units 0 to “n”). The variables z, y, x, and w are assigned values by the user. The user may set the values z and y by inserting the desired values into a field designated by the system (10), by using a cursor to drag the rows or columns of the display of the spreadsheet to increase of decrease the values of z and y, or by any other manner known in the art for inserting values into a software program. As the user adjusts the values of z and y, the system (10) reflects those changes by increasing or decreasing the number of rows and columns to the desired number.

Similarly, the user may set the values x and w by inserting the desired values into a field designated by the system (10), by using a cursor to drag a particular cell to a desired spot in the spreadsheet or by any other manner known in the art for inserting values into a software program. If the user uses the cursor to drag a cell to the desired location, the system (10) continuously determines the new x and w values for the current position of the cell in real time.

Once the variables z, y, x, and w are defined, the system (10) nests loops (74) and (76) to position or reposition the cells within the spreadsheet. The first loop (74) performs a function on each row 1-z. That function is loop (76) that performs a function on each cell 1-y in a given row. For each cell, loop (76) determines (78) if the current cell is the first cell in the current row. If the current cell is the first cell of the row, the system (10) positions (80) the left side of the current cell a predetermined distance “w” to the right of the left side of the spreadsheet document. If the current cell is not the first cell of the row, the system (10) positions (82) the left side of the current cell a predetermined distance “w” to the right of the right side of the previous cell in the same row.

The system (10) then determines (84) if the current cell is in the first row of the spreadsheet. If the current cell is in the first row of the spreadsheet, the system (10) positions (86) the top of the current cell a predetermined distance “x” down from the top of the spreadsheet document. If the current cell is not in the first row of the spreadsheet, the system (10) positions (88) the top of the current cell down a predetermined distance “x” from the bottom side of the previous row. The system (10) then determines (89) if that was the only row on the page and if the row fits on the page and, if so, ends (90). If not, the system adds a page and/or performs loop (76) on all cells 1-y in the current row and then performs loop (74), which incorporates loop (76) on all rows 1-x in the current spreadsheet. Once the system (10) performs loop (76) on all cells 1-y of a particular row, loop (76) ends (90) and the system (10) returns to loop (74) to run loop (76) on all cells 1-y of the next row in the spreadsheet. This process repeats until the system (10) performs loop (74) on all rows in the spreadsheet, at which point loop (74) ends (92).

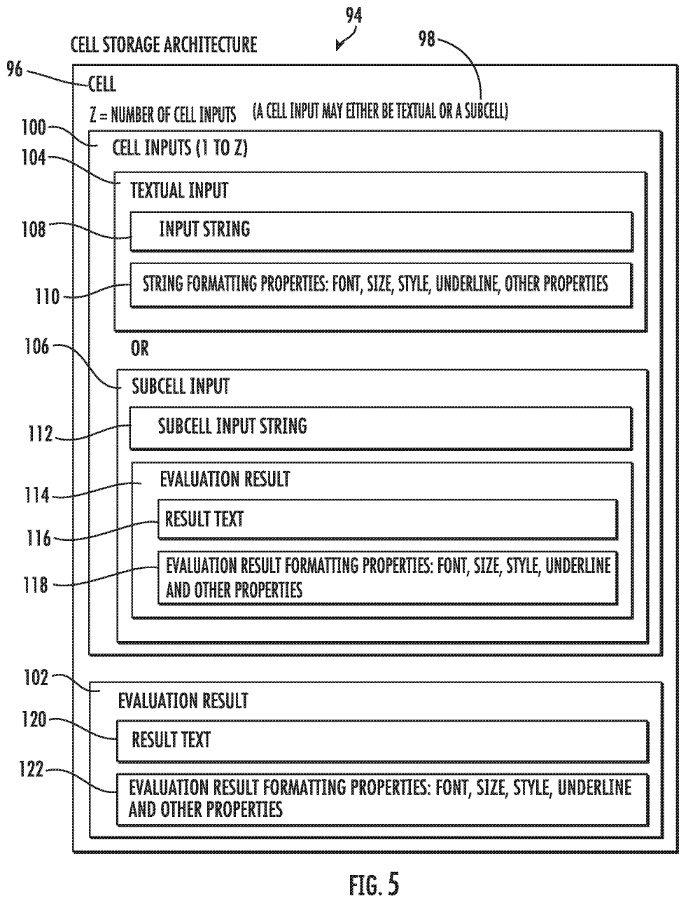

FIG. 5 illustrates a cell storage architecture (94) of a cell (96) of the spreadsheet (22) which includes subcells (98) according to one embodiment. The items stored within the cell storage architecture (94) of a cell (96) are cell inputs (100) and an evaluation result (102). Although not shown, the cell storage architecture (94) of this embodiment may contain, in addition to the improvement described herein, any other desired cell storage architecture known in the art. As shown, a cell (96) may contain one or more cell inputs (100), identified as cell inputs 1-z. A cell input according to the present embodiment may be a nonevaluable and/or evaluable cell input, such as a textual input (104) or a subcell input (106). Textual inputs (104) are nonevaluable. Textual inputs (104) consist of an input string (108) and string formatting properties (110). An input string (108) may contain numeric, alphabetic or other character based input used in the prior art. String formatting properties (110) contain the properties which are used to format and display the input string (108) to the display (16) when the cell inputs (104) are determined to be nonevaluable. Subcell inputs (106) are evaluable and contain an evaluable subcell input string (112) and an evaluation result (114). Evaluation result (114) contains the result text (116) and the evaluable result formatting properties (118). The result text (116) is used to store the result of the evaluation of the evaluable subcell input string (112). Evaluable result formatting properties (118) contain the properties which are used to format and display the result text (120) to the display (16). Evaluation result (102) contains result text (120) and evaluable result formatting properties (122). The result text (120) is used to store the result of the evaluation of the cell inputs (100) when the system (10) determines the cell inputs (100) to be evaluable. Evaluable result formatting properties (122) contain the properties which are used to format and display the result text (120) to the display (16).

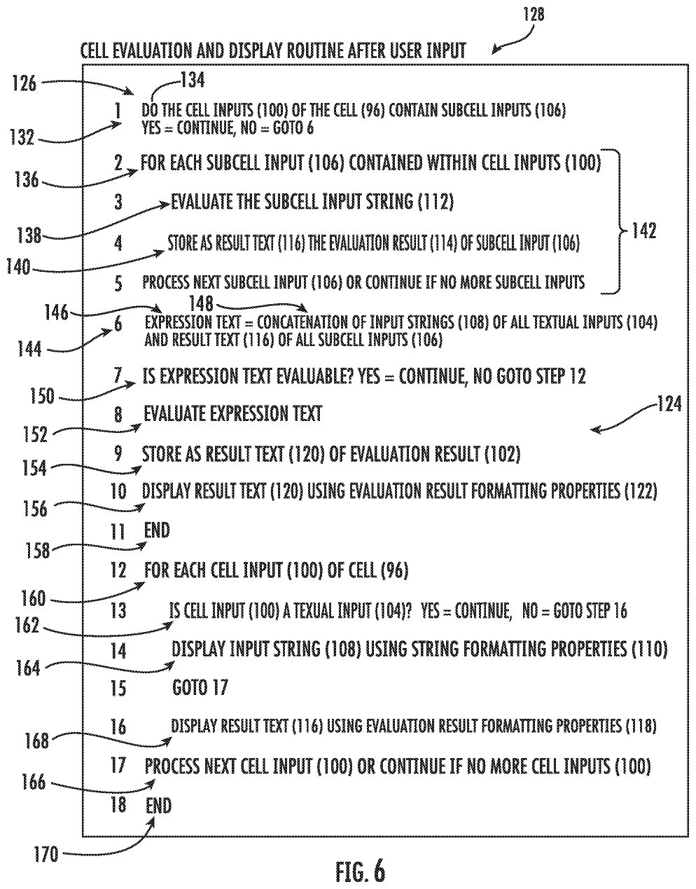

FIG. 6 illustrates pseudocode (124) explaining the coding architecture of the present invention to be used as an improvement to be implemented in association with prior art software code used to generate spreadsheets and spreadsheet functionality, such as that software well-known in the art. The pseudocode (124) adds functionality to a base spreadsheet software architecture, such as that described above in association with FIG. 5 and relating to cell evaluation, formatting and display of cell contents upon receipt of user-specified cell inputs (100). As shown in FIG. 6 upon receipt of a cell input (100) from a user (130), the system (10) calls (126) the cell evaluation and display routine (128). The cell evaluation and display routine (128) begins (132) by determining (134) if the cell inputs (100) of the cell (96) contain subcell inputs (106). If the cell inputs (100) of the cell (96) do contain subcell inputs (106), the system (10) loops (136) and evaluates (138) each subcell input (106) in a manner such as that known in the prior art to evaluate evaluable cells in spreadsheet systems. The system (10) stores (140) the result of the evaluation (138) within the result text (116) of the evaluation result (114) of the subcell input (106). The system (10) repeats the loop (142) until all subcell inputs (106) have been evaluated (138).

If there are no subcell inputs (106) or the loop (142) has completed, the system (10) defines (144) an expression text (146) as the concatenation (148) of all input strings (108) of all textual inputs (104) with all result text (116) of all subcell inputs (106). System (10) then determines (150) if the newly defined expression text (146) is evaluable. If the newly defined expression text (146) is evaluable, the system (10) evaluates (152) the expression text (146) in a manner such as that known in the prior art to determine and store (154) the result text (120) of the evaluation result (102). The system (10) then displays (156) the result text (120) using the evaluable result formatting properties (122) to the display (16) and the cell evaluation and display routine (128) ends (158).

If the system (10) determines (150) the newly defined expression text (146) is not evaluable, the system (10) loops (160) through each cell input (100) of cell (96) to determine (162) if a cell input (100) is a textual input (104). If the cell input (100) is a textual input (104), the system (10) displays (164) the input string (108) using string formatting properties (110) of the textual input (104) to the display (16) before processing (166) the next cell input (100). If the system (10) determines (162) the cell input (100) is a subcell input (106) the system (10) displays (168) the result text (116) using evaluation result formatting properties (118) of the evaluation result (114) of the subcell input (106) to the display (16) before processing (166) the next cell input (100). The system (10) repeats the loop (160) for all cell inputs (100). Once the system (10) has displayed (164) and (168) all cell inputs (100) the cell evaluation and display routine (128) ends (170).

As shown in FIG. 7, system (10) can be used for the precise placement of cells (34) in a table (50) of a spreadsheet application (22) supporting spreadsheet functionality. The spreadsheet application (22) can either be stand alone, or provided in combination with other systems. For example, the spreadsheet application (22) may be provided within a word processing document (214). An digital spreadsheet table (216) is shown in FIG. 7 provided within a word processing document (214) having a plurality of rows (218) and a plurality of columns (220) displaying an array of information cells (234) arranged in a matrix having a first row (222) of a plurality of cells (234) and a first column (228) of a plurality of cells (234). In the first row (222), cell B1 (224) and cell C1 (226) are contiguous, as known in the art. Similarly, in the first column (228), cell A2 (230) and cell A3 (232) are also contiguous. The improvement of system (10) over the prior art is the ability of system (10) to allow rows (218), columns (220), and cells (234) to be positioned independently of one another without the prior art requirement that they be contiguous with one another.

As a result of system (10) not requiring alignment or adjacency, each row (218) may have a different number of columns (220) and each column (220) may have a different number of rows (218). The table (216) in this embodiment is provided with column headers (236) and row identifiers (238). Given that each column (220) may have a different number of rows (218), not every column header (236) may have a corresponding cell (230) in a given row (218). For example, in table (216), the second header (240), “B,” corresponds to cells in a second column (242), including, but not limited to, cell B1 (224) in the first row (222), cell B2 (244) in a second row (246), and cell B3 (248) in a third row (250), even though the first row (222) and the second row (246) are spaced apart and noncontiguous, without any intervening rows or cells. Despite cells B1 (224), B2 (244), and cell B3 (248) not all being contiguous, executing a column selection operation on the second column (242), in a manner such as that known in the art, selects all of the cells in the second column (242), including cells B1 (224), B2 (244), and cell B3 (248), without selecting cells form any column other than the second column.

Cell B1 (224) defines a first border (252) and cell B2 (244) defines a second border (254). As shown in FIG. 7, despite cell B1 (224) and cell B2 (244) both being in the second column (242) (and both having an identical column reference, “B,” in their cell references B1 and B2), and despite cell B2 (244) being the next subsequent cell in the second column (242) after cell B1 (224), no portion of border (252) is contiguous with border (254). In this embodiment some cells, such as cell B5 (258) even have a left border (260) located right of a right border (262) of cell B3 (248) in that same column (242). Similarly, despite a cell, such as cell B5 (258) in the fifth row (200) being the next subsequent cell to cell A5 (256) in that same row (200), no portion of a border (202) defined by cell B5 (258) is contiguous with any portion of a border (204) defined by cell A5 (256).

Despite the noncontiguous and unaligned relationship of the cells in the second column (242), all of the cells (268) in that column (242) may be selected and modified using known spreadsheet column functions, such as the select function, summation function, etc. For example, despite cell B2 (244) and cell B5 (258) not being aligned, if a column selection function of the spreadsheet application (22) is used to select all cells in the second column (242), cells B2 (244) and B5 (258) would be included in the selection, while cell A4 (270) would not be included, despite cell A4 (270) being positioned below cell B2 (244).

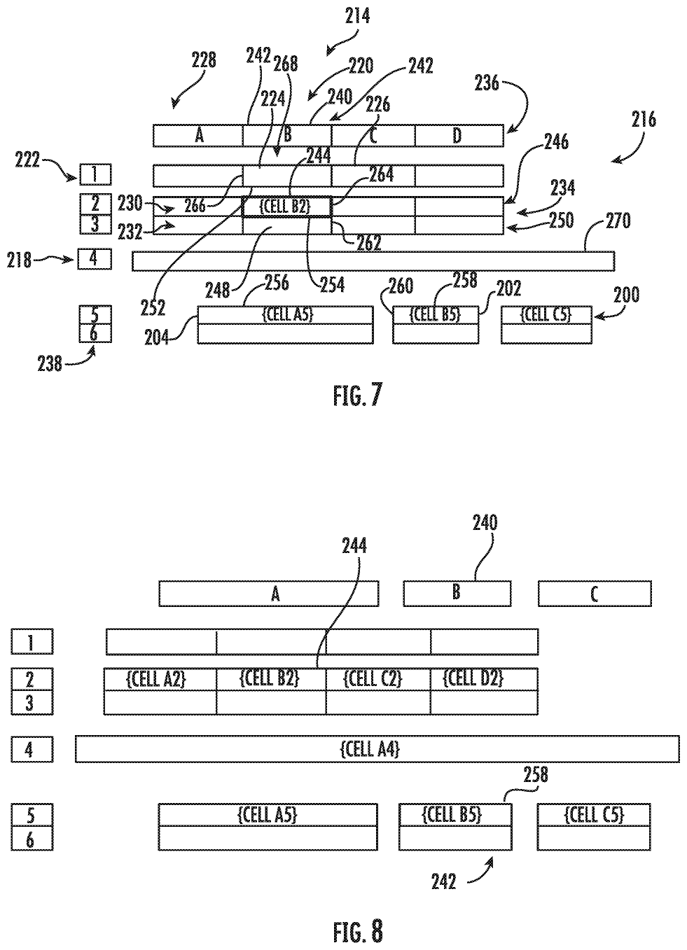

In this embodiment, the column headers (236) migrate to assist in determining with which column a particular cell (234) is associated. For example, as shown in FIG. 7, when cell B2 (244) is selected, using a cursor, or other selection method known in the art, the second header (240) is positioned over cell B2 (244). However, as shown in FIG. 8, when cell B5 (258) is selected, the second header (240) snaps into position over cell B5 (258) to indicate cell B5 (258) is associated with the second column (242). Although cell B2 (244) is also in the second column (242) associated with the second header (240), the second header (242) is not positioned over cell B2 (244) as it was in FIG. 7, because in FIG. 8 cell B5 (258) is selected, rather than cell B2 (244). If B2 (244) were to be selected again, the second header (242) would return to being positioned over cell B2 (244) as it was in FIG. 7. Similarly, whatever cell (234) is selected, the corresponding column header (236) will snap into alignment above the selected cell (234). Preferably, the column header (236) snaps into a position above the selected cell (234) where a centerline of the column header (236) is in alignment directly above a centerline above the selected cell (234).

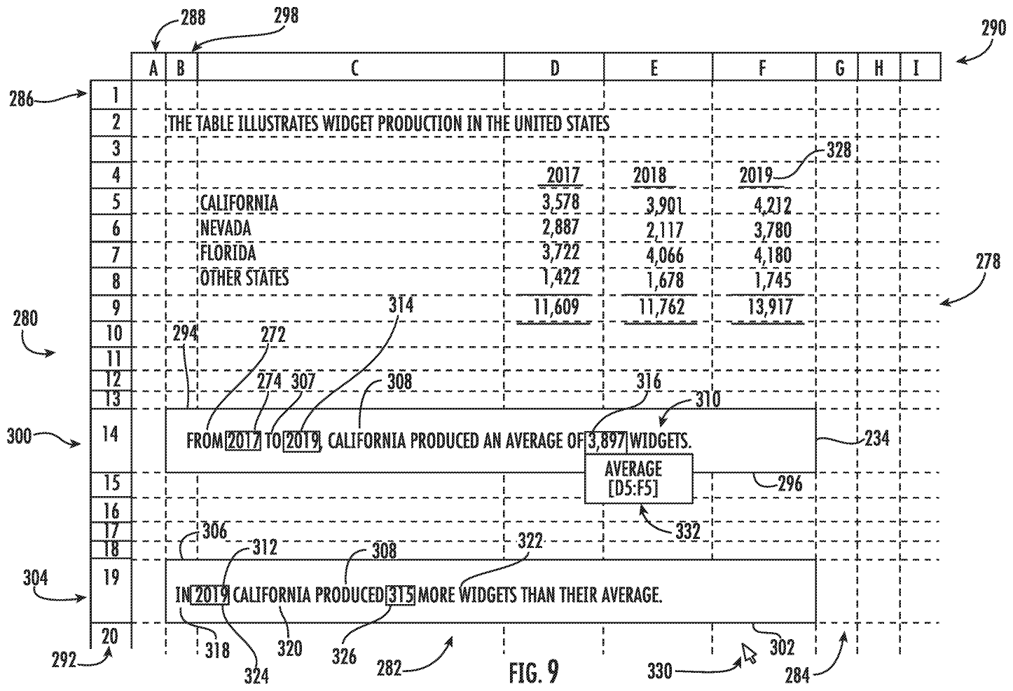

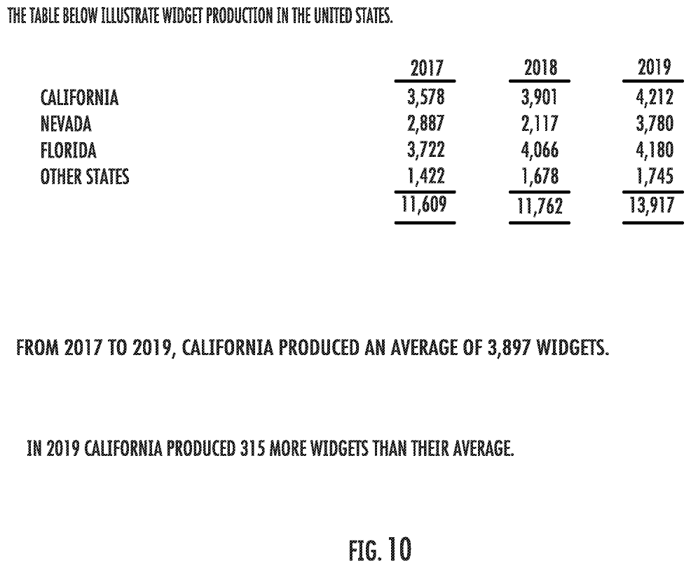

As shown in FIG. 9, system (10) can be used to place both nonevaluable text (272) and evaluable subcells (274) within cells (234) in a table (278) of a spreadsheet application supporting spreadsheet functionality. If desired, the table (278) may be provided within a word processing document (276). A digital spreadsheet table (278) is shown in FIG. 9, having a plurality of rows (280) and columns (282) displaying an array of information cells (284) arranged in a matrix having a first row (286) and a first column (288). The table (278) is provided with column headers (290) and row numbers (292) that may be combined to create a unique cell reference identifying a particular information cell (284) in the table (278). For example, a cell (296) in the second column (298) and fourteenth row (300) has a cell reference of B14. Similarly, a cell (302) in the second column (298) and ninteenth row (304) has a cell reference of B19.

System (10) places both nonevaluable text (272) and evaluable subcells (274) within cells (284) of the table (278) in the manner described above. FIG. 9, shows one embodiment of nonevaluable text (272) and evaluable subcells (274) displayed within a single cell (296). As shown, cell (296) contains nonevaluable text (272), (307), (308), and (310). Nonevaluable text (272) is the word “From,” nonevaluable text (307) is the word “to,” nonevaluable text (308) is the words “California produced and average of,” and nonevaluable text (310) is the word “Widgets.”

Cell (296) also contains multiple evaluable subcells (274), (314), and (316). Cell (296) may contain any known type of computer or user-specified information quantity including, but not limited to: a computer or user-specified operation, a computer or user-specified operand, a computer or user-specified portion of text, etc. Since the evaluable subcells (274), (314), and (316) are all contained within cell (296), having cell reference of B14, subcell (274) is associated with cell reference B14a, subcell (314) is associated with cell reference B14b, and subcell (316) is associated with cell reference B14c. Subcells may contain text, numbers, formulas, or any known spreadsheet operand. For example, in this embodiment, subcell (274) contains a user-specified operation such as formula “=D4,” subcell (314) contains the formula “=F4,”and subcell (316) contains the formula “=average(D5:F5)” that, when performed on an operand or operation, produce a resulting value. Subcells (274) may even include other subcells (274) within their formulae. Alternatively, subcell (312) may contain a user-specified operand.

Similarly, cell (302) contains a user-specified portion of text such as nonevaluable text (318), (320), and (322). Nonevaluable text (318) is the word “In,” nonevaluable text (320) is the words “California produced,” and nonevaluable text (322) is the words “more Widgets than their average.”

Cell (302) also contains multiple evaluable subcells (324) and (326). Since the evaluable subcells (324) and (326) are all contained within cell (302), having cell reference of B19, subcell (324) is associated with cell reference B19a and subcell (326) is associated with cell reference B19b. In this embodiment, in its formula, subcell (324) references another subcell (314), namely evaluable subcell B14b. Subcell (324) contains the formula “=B14b,” so that if the value of cell (328) associated with cell reference F4 changes, the value of evaluable subcell (314) automatically changes which, in turn, automatically changes the value of evaluable subcell (312). In its formula, “=F5-B14c” evaluable subcell (326) also references another subcell (316), namely evaluable subcell B14c.

As shown in FIG. 9, when it is desired to edit text within a cell (296), a user (not shown) uses a mouse (20) to manipulate a cursor (330) across a display (16) to position the cursor (330) over the cell (296). If the user desires to edit nonevaluable text (272) in the cell (296), the user positions the cursor (330) over the nonevaluable text (272) and begins editing. The user may select, copy, paste, and edit the nonevaluable text (272) within the cell (296) using word processing functions known in the art. If it is desired to edit an evaluable subcell (316), just like result text in prior art spreadsheet cells may not be directly edited, an evaluable subcell (316) may not be directly edited. Instead, as shown in FIG. 9, to edit an evaluable subcell (316) in this embodiment, the user positions the cursor (330) over the evaluable subcell (316). As shown in FIG. 9, this causes an input box (332) to be displayed. The user positions the cursor (330) over the input box (332) and uses the mouse (20) and/or keyboard (18) to make any desired edits to the evaluable subcell (316) in any manner known in the art.

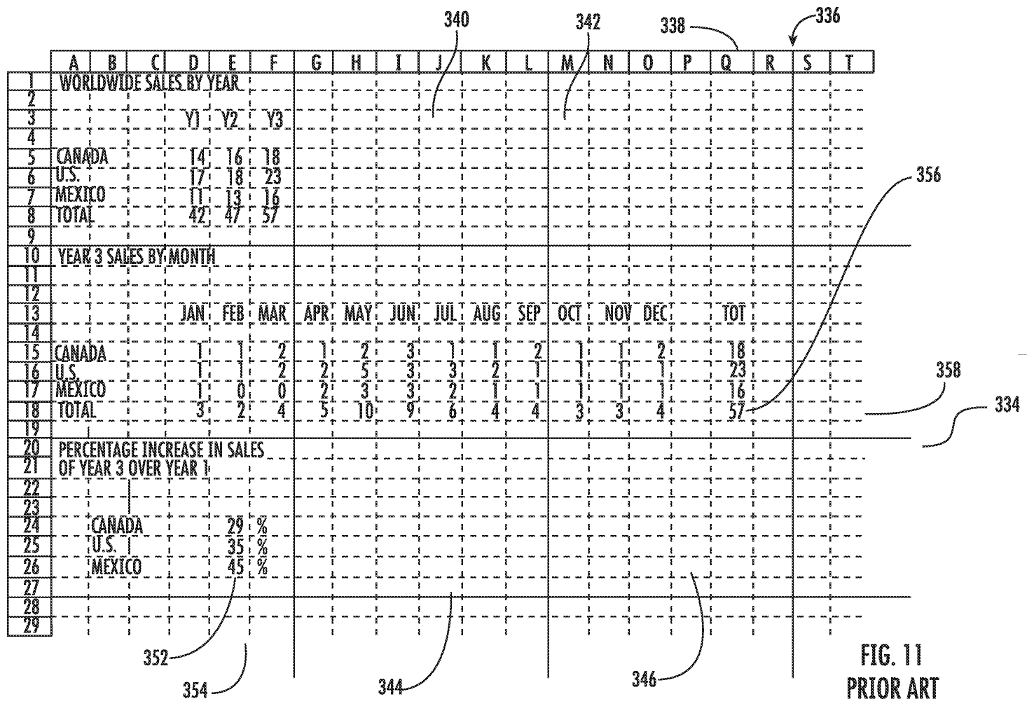

FIG. 11 illustrates a table (334) associated with a prior art spreadsheet (336). As shown, the table (334) spans nine pages (338). Even though four of the pages (340), (342), (344), and (346) contain no data in any cells (348) on those pages (340), (342), (344), and (346), eliminating those pages (340), (342), (344), and (346) from the table (334) in the prior art spreadsheet (336) is difficult, if not impossible as prior art spreadsheets automatically extend columns (348) and rows (350) to equal the last cell (352) containing a value in the longest column (354) and the last cell (356) containing a value in the longest row (358). This creates a table (334) that while rectangular, contains many empty cells that needlessly occupy computer memory and make the table (334) harder to read.

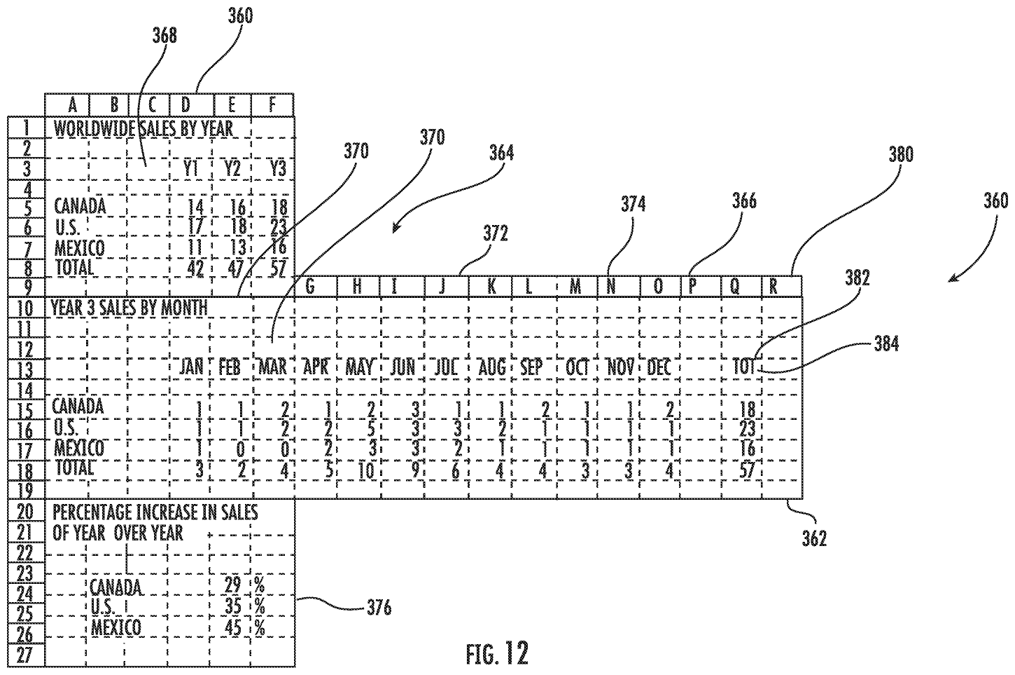

An improvement over the prior art, as embodied in one embodiment of the present invention, is shown generally as (360) in FIG. 12. As shown in FIG. 12, a table (362) associated with a spreadsheet (364) of one embodiment of the present invention may be produced that contains all of the cells having values of the prior art table (334) of the prior art, as shown in FIG. 11, and requires only five pages (366) instead of nine. This embodiment eliminates all of the pages containing no data to reduce memory requirements of the table (362), making the table (362) easier for computer memory (14) to store and manipulate. The elimination of the pages containing no data also makes the resulting table (362) easier to read.

As shown, system (10) only displays those pages (368), (370), (372), (374), and (376) containing cells with data. To make table (362) easier to read, and to eliminate the need for superfluous pages, system (10) automatically moves column headers (378) and (380) to the first pages (374) and (376), when viewed downward, displaying cells (382) with values (384).

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. In an electronic spreadsheet system for storing and manipulating information, a computer-implemented method of generating and displaying evaluable spreadsheet, the method comprising:
a. generating a document, wherein the document comprises:
i. a table supporting spreadsheet functionality, the table comprising:
a) an array of information cells arranged in a matrix having a row and a column;
b) a predetermined cell of the array of information cells, the predetermined cell comprising:
i) an input area;
ii) a subcell;
b. receiving a first input;
c. inputting the first input into the input area, wherein the input area is not evaluable;
d. receiving a second input;
e. inputting the second input into the subcell, wherein the subcell is evaluable;
d. displaying the predetermined cell on a display in a manner where the first input is displayed in the predetermined cell at the same time as an evaluation result of the second input is displayed in the predetermined cell, wherein the evaluation result of the second input is different than the second input.

2. The method of claim 1, wherein at least a portion of the predetermined cell is evaluable.

3. The method of claim 1, wherein the first input is text.

4. The method of claim 2, wherein the second input is numerical.

5. The method of claim 2, wherein the second input is a mathematical expression.

6. The method of claim 1, wherein the second input is numerical.

7. The method of claim 1, wherein the second input is a mathematical expression.

8. The method of claim 1, further comprising determining the evaluation result by implementing on the second input one or more user-specified operations, as defined by one or more operators.

9. The method of claim 1, wherein the input area is not contained within the subcell.

10. The method of claim 9, wherein the subcell is not contained within the input area.

11. The method of claim 1, wherein the subcell is not contained within the input area.

12. In an electronic spreadsheet system for storing and manipulating information, a computer-implemented method of generating and displaying evaluable spreadsheet subcells, the method comprising:
generating a document, wherein the document comprises:
a table supporting spreadsheet functionality, the table comprising:
an array of information cells arranged in a matrix having a first row and a first column; and
a predetermined cell of the array of information cells, the predetermined cell comprising:
an input area, wherein the input area comprises at least one input that is not evaluable; and
a subcell, wherein the subcell comprises at least one input that is evaluable; and
displaying the predetermined cell on a display in a manner wherein the at least one input that is not evaluable is displayed in the predetermined cell at the same time an evaluation result of the at least one input that is evaluable is displayed in the predetermined cell.

13. The method of claim 12, wherein the as least one input that is not evaluable comprises a user-specified portion of text and wherein the evaluation result comprises the result of performing, using a computer on the at least one input that is evaluable, one or more user-specified operations, as defined by one or more operators, to determine the evaluation result.

14. The method of claim 12, wherein at least a portion of the predetermined cell is evaluable.

15. The method of claim 12, wherein the at least one input that is not evaluable is text.

16. The method of claim 12, wherein the evaluation result is numerical.

17. The method of claim 12, wherein the evaluation result is a user-specified number.

18. The method of claim 12, wherein the evaluation result is the result of performing a user-specified operand on the at least one input that is evaluable.

19. In an electronic spreadsheet system for storing and manipulating information, a computer-implemented method of generating and displaying evaluable spreadsheet subcells, the method comprising:
generating a document, wherein the document comprises:
a table supporting spreadsheet functionality, the table comprising:
an array of information cells arranged in a matrix having a first row and a first column; and
a predetermined cell of the array of information cells located in the first column, the predetermined cell comprising a nonevaluable user-specified portion of text and an evaluable subcell comprising an evaluation result; and
displaying the predetermined cell on a display in a manner wherein the nonevaluable user-specified portion of text is displayed in the predetermined cell at the same time as the evaluation result is displayed in the predetermined cell.

20. The method of claim 19, wherein at least a portion of the predetermined cell is evaluable.
